(19) United States
(12) Patent Application Publication
(10) Pub. No.: US 2020/0084206 A1
(43) Pub. Date: Mar. 12, 2020

(54) Two Factor Authentication Using Audio Communication Between Machines with and without Human Interaction

(71) Applicant: Georgetown University, Washington, DC (US)

(72) Inventors: Tavish Vaidya, Annandale, VA (US); Micah Sherr, Silver Spring, MD (US)

(73) Assignee: Georgetown University, Washington, DC (US)

(21) Appl. No.: 16/564,386

(22) Filed: Sep. 9, 2019

Related U.S. Application Data
(60) Provisional application No. 62/730,186, filed on Sep. 12, 2018.

(51) Int. Cl. H04L 29/06; G10L 17/24

(52) U.S. Cl. CPC H04L 63/0861; H04L 2463/082; G10L 17/24; H04L 63/0853

(57) ABSTRACT

Embodiments of the present systems and methods may provide techniques for two-factor authentication (2FA) that leverage voice assistant devices such as Google Home and Amazon Echo. For example, in an embodiment, a computer-implemented method of authentication may comprise receiving an authentication request for a user of a service, authenticating the user using two-factor authentication, wherein at least one factor of the two-factor authentication is audio, and validating the authentication request upon validation of both factors of the two-factor authentication.

### CROSS-REFERENCE TO RELATED APPLICATIONS

This application claims the benefit of U.S. Provisional Application No. 62/730,186, filed Sep. 12, 2018, the contents of which are incorporated herein in their entirety.

### BACKGROUND

The present invention relates to techniques for performing two-factor authentication (2FA) that leverages voice assistant devices such as Google Home, Amazon Echo or any other computing device capable of receiving voice input and running a voice assistant.

Two-factor authentication (2FA) is a secure method of authenticating to a service, such as a website, which requires two forms or factors of authentication. Typically, the two factors include a password and a code that proves physical possession of a device, such as a smartphone or key fob. An example of the workflow for conventional 2FA is shown in FIG. 1 and is as follows: a computer user visits a website and enters his/her password. The website then sends a text message to the user's phone containing a passcode of, for example, 6-8 random digits. In some systems, the passcode is mathematically derived on the device itself and also independently derived by the web service on its own. These two independent and equal derivations obviate the need to send the code. In both cases, the user must fetch his/her phone, read the passcode, and enter the digits from the passcode into his/her web browser. This proves to the website that a user who is attempting to log in (1) has knowledge of the password associated with the account and (2) has physical possession of the smartphone that is registered with the account. These two factors are preferable to password-only, single factor, authentication, since neither the loss of a password alone nor the loss of a device by itself will compromise access.

The problem with traditional 2FA—and one which has led to very slow adoption rates—is that it is cumbersome. Although conceptually simple, it requires the user to potentially leave his/her seat and locate his/her phone. Then, the user has to navigate to the appropriate app, read the code, memorize it, and then re-enter it on a web browser. Additionally, configuring 2FA requires additional steps such as scanning a barcode or manually entering a code.

Accordingly, a need arises for techniques for two-factor authentication that are less cumbersome and easier to use.

### SUMMARY

Embodiments of the present systems and methods may provide techniques for two-factor authentication (2FA) that leverage voice assistant devices such as Google Home and Amazon Echo. In embodiments, a voice-based form of 2FA may automate many of these otherwise manual steps involved in 2FA. Embodiments may provide the capability for a website to issue a voice command (potentially using the computer user's speakers), which is then acted upon by the user's nearby voice assistant. This voice command causes the voice assistant to send an electronic unforgeable message to the website that attests to the user's physical proximity to his/her voice assistant. Hence, without leaving his/her seat, the website and the user are successfully able to complete a 2FA login, since logging in now requires both the password and physical possession of (or more accurately, physical proximity to) the user's voice assistant.

For example, in an embodiment, a computer-implemented method of authentication may comprise receiving an authentication request for a user of a service, authenticating the user using two-factor authentication, wherein at least one factor of the two-factor authentication is audio, and validating the authentication request upon validation of both factors of the two-factor authentication.

In embodiments, the audio may be an audio file or clip and the method may further comprise automatically playing the audio file or clip on a user device of the user to a voice assistant enabled device. The audio may be spoken by the user and the method may further comprise automatically displaying text representing a phrase on a user device of the user, the phrase to be read by the user to a voice assistant enabled device.

In an embodiment, a computer-implemented method of authentication may comprise receiving an authentication request for a user of a service, the authentication request originating at a user device of the user, generating a phrase and transmitting the phrase to the user device, receiving audio information from a voice assistant enabled device, the audio information being a representation of an audio rendition of the generated phrase received by the voice assistant enabled device, verifying that the audio information corresponds to the generated phrase; and transmitting a validation of the authentication request to the user device upon verifying that the audio information corresponds to the generated phrase.

In embodiments, the phrase may be transmitted as an audio file or clip and the method may further comprise automatically playing the audio file or clip on the user device to the voice assistant enabled device. The phrase may be transmitted as text and the audio may be spoken by the user as the user reads the text to the voice assistant enabled device.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 illustrates an exemplary prior art two-factor authentication technique.

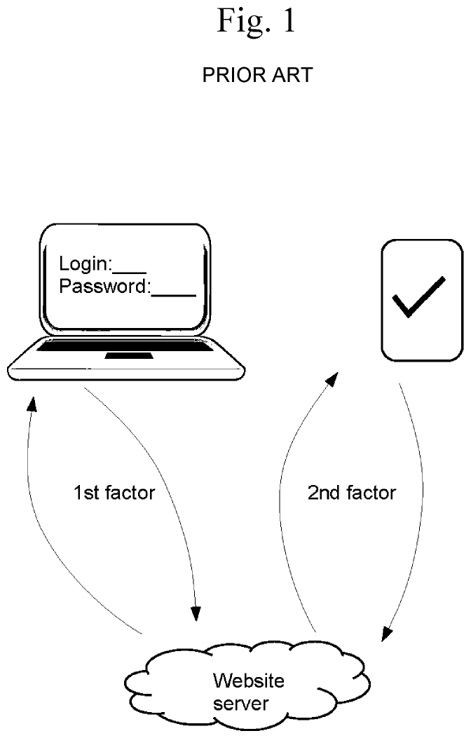

FIG. 2 is an exemplary block diagram of a system in which embodiments of the present systems and methods may be implemented.

FIG. 3 is an exemplary flow diagram of a process of operation of the system shown in FIG. 2, in accordance with embodiments of the present systems and methods.

FIG. 4 is an exemplary data flow diagram of the process shown in FIG. 3, in accordance with embodiments of the present systems and methods.

FIG. 5 is an exemplary illustration of a computer system in which embodiments of the present systems and methods may be implemented.

### DETAILED DESCRIPTION

Embodiments of the present systems and methods may provide techniques for two-factor authentication (2FA) that leverages voice assistant devices such as Google Home and Amazon Echo. In embodiments, a voice-based form of 2FA may automate many of these otherwise manual steps involved in 2FA. Embodiments may provide the capability for a website to issue a voice command (potentially using the computer user's speakers), which is then acted upon by the user's nearby voice assistant. This voice command causes the voice assistant to send an electronic unforgeable message to the website that attests to the user's physical proximity to his/her voice assistant. Hence, without leaving his/her seat, the website and the user are successfully able to complete a 2FA login, since logging in now requires both the password and physical possession of (or more accurately, physical proximity to) the user's voice assistant.

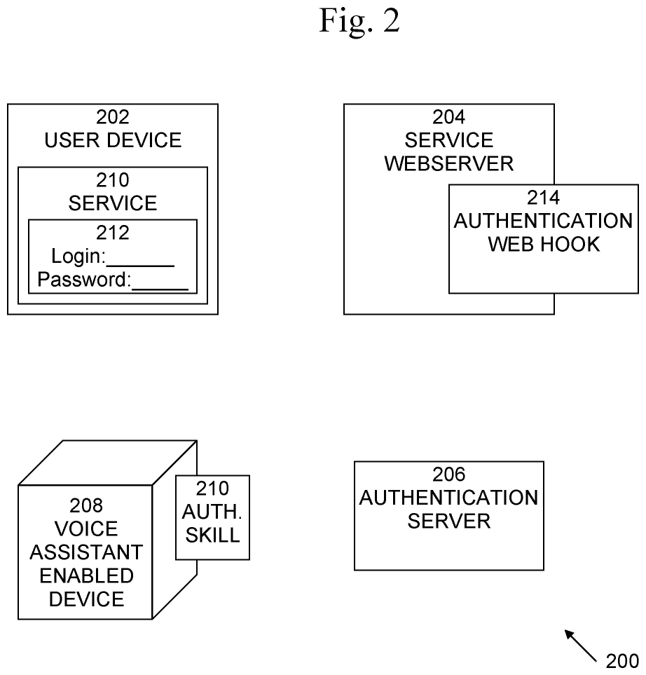

An exemplary system 200 in which embodiments of the present systems and methods may be implemented is shown in FIG. 2. System 200 may include a user device 202, a service webserver 204, an authentication server 206, and a voice assistant enabled device 208. User device 202 may be a device, such as a desktop computer, laptop, tablet, etc., which may be running an application or accessing a webpage that provides access to service 210. User device 202 may be used by a user to access Service 210 using, for example, the Internet. A “user” is a person who uses user device 202 to use Service 210. To access Service 210, a user first enters his username and password 212 and then may use the present techniques to provide the second factor required by Service 210 for successful authentication.

Service 210 may be any website, application, etc., which has user accounts and allows users to register themselves by creating accounts with credentials such as a username and password. The users may then use these credentials to log into their accounts on Service 210. In addition to using username/password as credentials (“something you know”), Service 210 may employ a second factor for authenticating its users. Conventional second factors may include biometrics, etc. (“something you are”) or additional information (“something you have”) from other devices, for example, a text message on a user's smartphone. Service 210 may employ embodiments of the present systems and methods to provide the second factor to authenticate its users.

Service Webserver 204 may include the computer hardware and software that runs the business logic of service 210 that the user is attempting to access. Service Webserver 204 may include or communicate with authentication web hook 214, which performs the business logic of the embodiments of the present systems and methods that run on the Service Webserver 204. Authentication web hook 214 may handle communication between Service Webserver 204 and the Authentication Server 206. Authentication Server 206 may include computer hardware and software to implement an Internet connected server that runs the business logic for embodiments of the present systems and methods. Authentication Server 206 may communicate with both Service Webserver 204 and VAED 208 to provide two-factor authentication.

VAED 208 may be any device capable of running a voice assistant, such as, but not limited to Amazon Echo or Google Home. VAED 208 may include authentication skill 210. Voice assistants such as Amazon Alexa support third party applications called “Skills” that allow third-party developers to build applications that take voice input from the user, process it, generate a response and return it to the voice assistant. These “skills” are roughly analogous to smartphone “apps.” One component of the present systems and methods is such a skill, authentication skill 210.

For purposes of the present invention, “skills” aren't necessarily limited to third party applications, and may also cover a similar functionality as authentication skill 210 natively built into the voice assistant itself. For example, Google or Amazon may themselves build a command and necessary business logic with their respective voice assistants to support 2FA over the voice channel. Therefore, in one embodiment, such functionality can be implemented as a third party skill or can be built into the voice assistant.

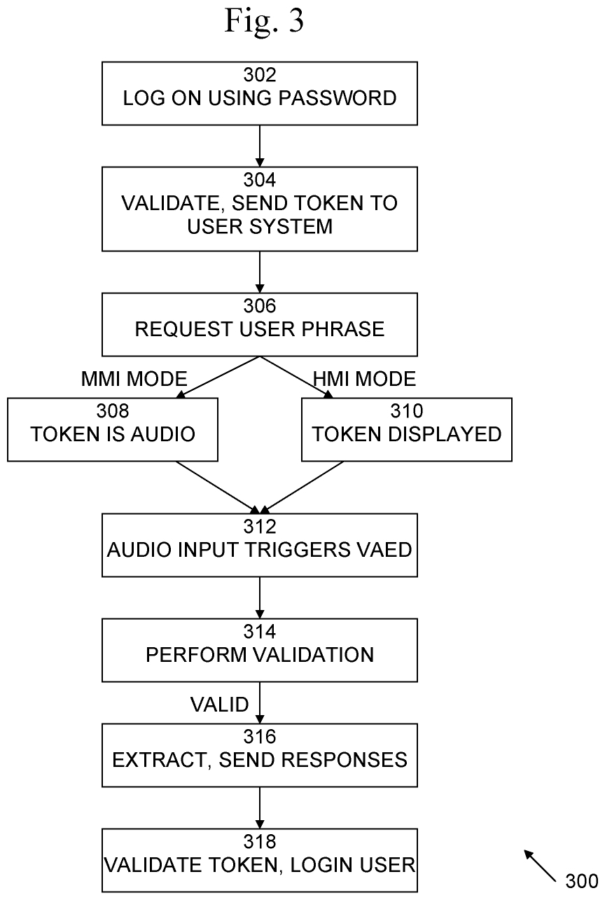

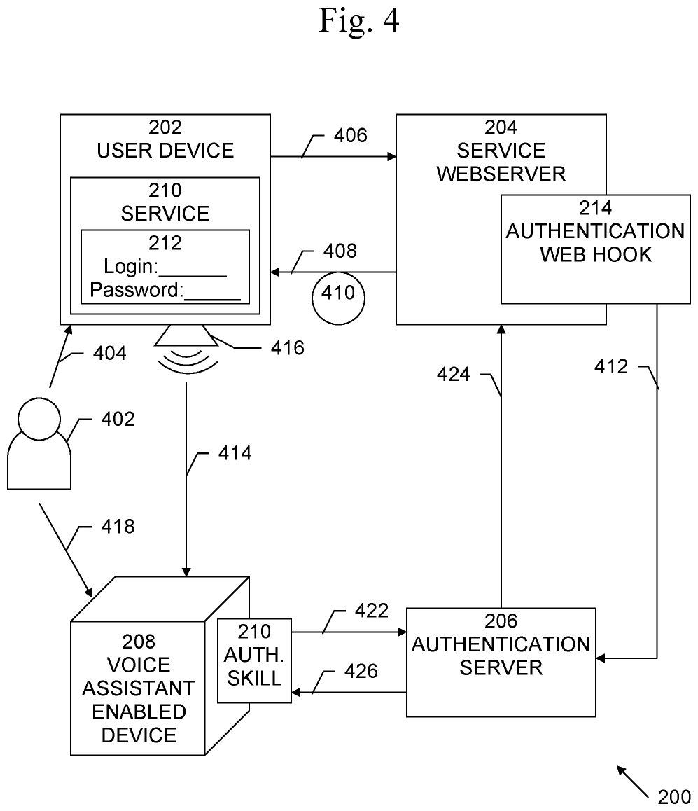

An exemplary flow diagram of a process 300 of operation of system 200 is shown in FIG. 3. It is best viewed in conjunction with FIG. 4, which is a data flow diagram of process 300 in system 200. Process 300 begins with 302, in which a user 402 may log into 404 the online Service 210 using user device 202 and login information including his/her username/login and password 212 (the first factor of authentication). At 304, Service Webserver 204 may receive the login information 406 and validate the information. If the login information is validated as belonging to a user of the service, Service Webserver 204 may generate a response 408 and send it back to user device 202 and user 403. Response 406 may include an authentication token 408, which may be pseudo-randomly generated. Authentication token 410 may, for example, be an audio signal, or a phrase, depending on the mode of operation (discussed below). Authentication token 410, along with other data, may be sent as response 408 to user device 202.

At 306, in addition to sending response 408 to user device 202, Service Webserver 204 may also send a request for a user phrase, UserPhraseRequest 412, to the Authentication Server 206 via Authentication Web Hook 214. UserPhraseRequest 412 may include information about the user 402 being authenticated. Authentication Server 206, on receiving the UserPhraseRequest 412, may queue it until a response is available.

Depending on the mode of operation, one of the following then occurs. In the machine-machine interaction mode, at 308, authentication token 410 may be an audio clip or file and user device 202 may communicate directly with VAED 208. For example, authentication token 410 (audio, in this mode) may be played 414 using speakers 416 on user device 202 to VAED 208. In the human-machine interaction mode, at 310, authentication token 410 may be a phrase that is displayed to user 402 on user device 202. Instead of user device 202 directly communicating with VAED 208, user 402 may read 418 the phrase to VAED 208.

Once the VAED 208 receives the voice input via any of the two described modes, the VAED 208 may use cloud based speech recognition services to transcribe the input audio. The majority of VAEDs today use this approach. However, future variations may allow VAEDs 208 to perform the transcription locally without enlisting the help of the cloud.

While VAED 208 is used in the present description, the VAED 208 may, in one embodiment, comprise a “VAED Ecosystem”, since VAED's like Amazon Echo etc. are backed by business logic in the cloud. Even for the transcription case, in one embodiment it is the cloud-based business logic that performs the transcription and then forwards the request to authentication server 206. The VAED Ecosystem may comprise a VAED 208 that may or may not have cloud-based intelligence that handles the requests on the VAED's 208 behalf.

Current VAED 208 ecosystems only provide transcriptions of audio spoken to the VAED 208 along with other metadata. However, in the future it may be the case that VAED 208 ecosystems may forward the audio input in audio form to third party skills in addition to or replacement of transcriptions. In such a scenario, the authentication server 206 may handle the task of transcription itself or enlist a cloud based transcription service.

In either mode of operation, audio has been received by VAED 208. At 312, audio 414 from user device 202 in machine-machine interaction mode or audio 418 from the user 402 in human-machine interaction mode, to VAED 208 may trigger an authentication skill 210 running on VAED 208. VAED 208 may forward the processed audio input, generate a skillRequest 422 via authentication skill 210, and may send skillRequest 422 to Authentication Server 206. The skillRequest 422 may include information about the user 402, VAED 208, and information from the audio input 414, 418 that was provided to VAED 208.

At 314, Authentication Server 206 may on receiving skillRequest 422, performs various validation checks to verify the authenticity and correctness of skillRequest 422. If skillRequest 422 is valid, then at 316, Authentication Server 206 may extract the user-related information and may look up the pending UserPhraseRequest 412 to see if there is a match based on the user information. If there is match, then Authentication Server 206 may extract the authentication phrase information 414, 418 from the skillRequest 422 and may send it to Authentication Web Hook 214 running on Service Webserver 204 as UserPhraseResponse 424. Additionally, Authentication Server 206 may also send a skillResponse 426 to VAED 208, which may convey that the authentication request was successfully forwarded to Service Web server 204.

At 318, on receiving the UserPhraseResponse 424, Service Webserver 204, via Authentication Web Hook 214, may match the user information and then may check if the authentication token 410 originally sent to user 402 at 304 matches the information received in the UserPhraseResponse 424 for user 402. If the information is correct, user 402 may be logged in successfully.

The Service Webserver 204 can also delegate the process of matching the authentication token to Authentication Server 206, if, in addition to UserPhraseRequest, it also sends the expected authentication token. If it does that, then the Authentication Server 206 can perform the actual verification by matching the authentication token received from the VAED 208 with the expected token received from the Service Webserver 204.

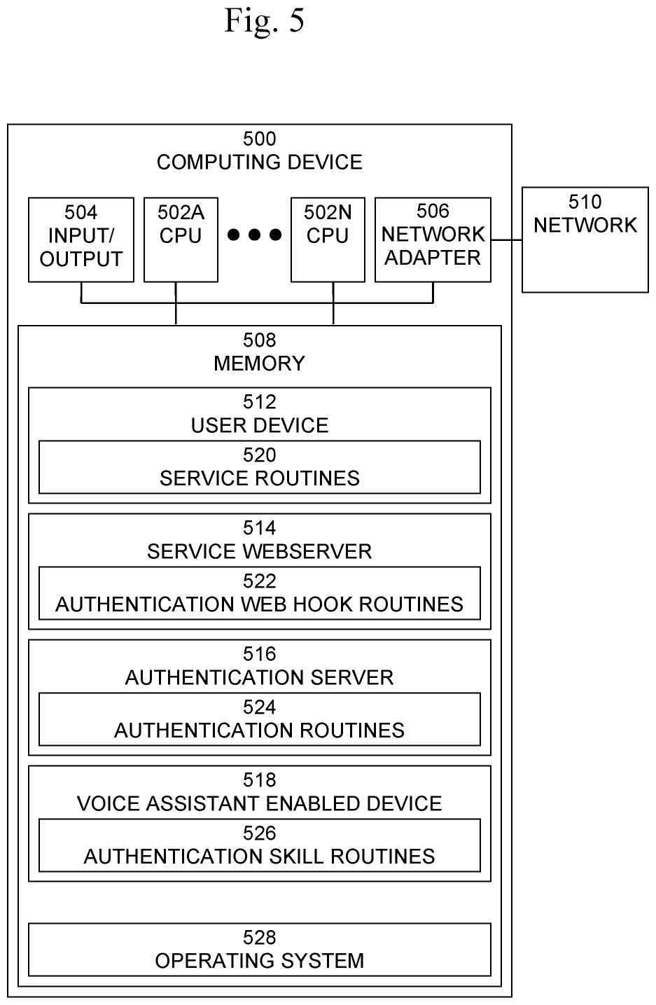

An exemplary block diagram of a computer system 500, in which processes involved in the embodiments described herein may be implemented, is shown in FIG. 5. Computer system 500 may be implemented using one or more programmed general-purpose computer systems, such as embedded processors, systems on a chip, personal computers, workstations, server systems, and minicomputers or mainframe computers, or in distributed, networked computing environments. Computer system 500 may include one or more processors (CPUs) 502A-502N, input/output circuitry 504, network adapter 506, and memory 508. CPUs 502A-502N execute program instructions in order to carry out the functions of the present communications systems and methods. Typically, CPUs 502A-502N are one or more microprocessors, such as an INTEL CORE® processor. FIG. 5 illustrates an embodiment in which computer system 500 is implemented as a single multi-processor computer system, in which multiple processors 502A-502N share system resources, such as memory 508, input/output circuitry 504, and network adapter 506. However, the present communications systems and methods also include embodiments in which computer system 500 is implemented as a plurality of networked computer systems, which may be single-processor computer systems, multi-processor computer systems, or a mix thereof.

Input/output circuitry 504 provides the capability to input data to, or output data from, computer system 500. For example, input/output circuitry may include input devices, such as keyboards, mice, touchpads, trackballs, scanners, analog to digital converters, etc., output devices, such as video adapters, monitors, printers, etc., and input/output devices, such as, modems, etc. Network adapter 506 interfaces device 500 with a network 510. Network 510 may be any public or proprietary LAN or WAN, including, but not limited to the Internet.

Memory 508 stores program instructions that are executed by, and data that are used and processed by, CPU 502 to perform the functions of computer system 500. Memory 508 may include, for example, electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra-direct memory access (UDMA), or a small computer system interface (SCSI) based interface, or a variation or enhancement thereof, such as fast-SCSI, wide-SCSI, fast and wide-SCSI, etc., or Serial Advanced Technology Attachment (SATA), or a variation or enhancement thereof, or a fiber channel-arbitrated loop (FC-AL) interface.

The contents of memory 508 may vary depending upon the function that computer system 500 is programmed to perform. In the example shown in FIG. 5, exemplary memory contents are shown representing routines and data for each of the devices shown in FIG. 2. However, one of skill in the art would recognize that these routines, along with the memory contents related to those routines, may not be included on one system or device, but rather may be distributed among a plurality of systems or devices, based on well-known engineering considerations. The present systems and methods may include any and all such arrangements.

In the example shown in FIG. 5, memory 508 may include memory contents 512 of user device 202, memory contents 514 of service webserver 204, memory contents 516 of authentication server 206, and memory contents 518 of VAED 208. Memory contents 512 of user device 202 may include service routines 520, which may include software routines to implement a user interface and processing for a service, which may a be website, application, etc., which has user accounts and allows users to register themselves by creating accounts with credentials such as a username and password. Memory contents 514 of service web server 204 may include authentication web hook routines 522, which may include software routines to implement the business logic of the embodiments of the present systems and methods that run on the Service Webserver 204. Memory contents 516 of authentication server 206 may include authentication routines 524, which may include software routines to implement an Internet connected server that runs the business logic for embodiments of the present systems and methods. Memory contents 518 of VAED 208 may include authentication skill routines 518, which may include software routines to implement authentication functionality for embodiments of the present systems and methods on VAED 208. Operating system 520 may provide overall system functionality.

As shown in FIG. 5, the present communications systems and methods may include implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including Linux, UNIX®, OS/2®, and Windows®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is difficult for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device.

The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A computer-implemented method of authentication comprising:
receiving an authentication request for a user of a service;
authenticating the user using two-factor authentication, wherein at least one factor of the two-factor authentication is audio; and
validating the authentication request upon validation of both factors of the two-factor authentication.

2. The method of claim 1, wherein the audio is an audio file or clip and the method further comprises:
automatically playing the audio file or clip on a user device of the user to a voice assistant enabled device.

3. The method of claim 1, wherein the audio is spoken by the user and the method further comprises:
automatically displaying text representing a phrase on a user device of the user, the phrase to be read by the user to a voice assistant enabled device.

4. A computer-implemented method of authentication comprising:
receiving an authentication request for a user of a service, the authentication request originating at a user device of the user;
generating a phrase and transmitting the phrase to the user device;
receiving audio information from a voice assistant enabled device, the audio information being a representation of an audio rendition of the generated phrase received by the voice assistant enabled device;
verifying that the audio information corresponds to the generated phrase; and
transmitting a validation of the authentication request to the user device upon verifying that the audio information corresponds to the generated phrase.

5. The method of claim 4, wherein the phrase is transmitted as an audio file or clip and the method further comprises:
automatically playing the audio file or clip on the user device to the voice assistant enabled device.

6. The method of claim 4, wherein the phrase is transmitted as text and the audio is spoken by the user as the user reads the text to the voice assistant enabled device.
